(19) United States
(12) Patent Application Publication
(10) Pub. No.: US 2025/0129701 A1
(43) Pub. Date: Apr. 24, 2025

(54) DETERMINING SPATIAL DISTRIBUTIONS OF PETROPHYSICAL PROPERTIES IN A SUBSURFACE FORMATION

(71) Applicant: Saudi Arabian Oil Company, Dhahran (SA)

(72) Inventors: Ramsin Eyvazzadeh, Dhahran (SA); Hassan Hasan Hamam, Dhahran (SA); Sherif Khattab, Dhahran (SA); Mohammed Hashim Alnasser, Al Khobar (SA)

(21) Appl. No.: 18/492,019

(22) Filed: Oct. 23, 2023

(51) Int. Cl. E21B 44/00; E21B 49/00; G01V 99/00; G06N 20/20

(52) U.S. Cl. CPC E21B 44/00; E21B 49/00; G01V 20/00; G06N 20/20; E21B 2200/20

(57) ABSTRACT

This disclosure describes systems and methods for determining spatial distributions of petrophysical properties in a subsurface formation. A method includes obtaining input data including petrophysical data, geophysical data and geological data of the subsurface formation; selecting input features from the input data; forming a training dataset including the input features and corresponding labeled data representing a target petrophysical property of the subsurface formation; training, using the training dataset, an ensemble machine learning model; and determining a spatial distribution of the target petrophysical property based on the trained ensemble machine learning model.

### TECHNICAL FIELD

The present disclosure relates to methods and systems for geological modeling of a subsurface formation.

### BACKGROUND

Geological modeling is a complex iterative process of creating representations of portions of the subsurface of the Earth. Geological models can integrate geological concepts, geophysical data, and rock and fluid properties. Three-dimensional (3D) geological models can be divided into individual 3D blocks called cells with properties associated with each cell. Geological modeling is useful, for example, in the oil and gas industry for mapping natural resources, identifying drilling hazards, and predicting behavior of the subsurface in reservoir simulations.

### SUMMARY

A critical task in the development of a geological model is the distribution of petrophysical properties in the model. This can be particularly important with datasets that have large differences in vertical resolution and geospatial coverage. For example, geophysical data can have large areal coverage but a low vertical resolution (e.g., 50 meters), while the areal coverage of geological data may be limited to the locations of the wells with a high vertical resolution (e.g., 1 meter).

This disclosure describes systems and methods for spatially distributing petrophysical properties within a three-dimensional subsurface geological model using an ensemble deep learning model. A data processing system (e.g., a computing system or a control system) obtains input data from geophysical data, geological data, and petrophysical data. The data processing system selects input features from the input data. The data processing system forms a training dataset including the input features and corresponding labeled data representing a target petrophysical property. The data processing system trains the ensemble machine learning model using the training dataset. Based on the trained model, the data processing system determines a spatial distribution of the target petrophysical property.

Implementations of the systems and methods of this disclosure can provide various technical benefits. Geological modeling is a highly complex iterative process that integrates geological concepts, geophysical data, and rock and fluid properties. The structural architecture of a 3D model is established by seismic reflections that produce wave velocities and attenuation in the subsurface. Statistical or deterministic techniques are later used to spatially distribute petrophysical properties (e.g., porosity, permeability, lithology) that are constrained by geological concepts (e.g., depositional systems). Due to the large variability in petrophysical properties, a subset of the variables can be distributed using kriging techniques that reduce variability by collocating the target attribute with input variables that have direct relationships. However, geospatial differences, such as differences in areal coverage and vertical resolution of the input variables, and weak relationships between collocated variables can introduce large errors in sequential geological modeling approaches. For example, a sequential approach can introduce systematic and random errors from preceding steps. In heterogenous formations with a high degree of complexity, a relationship between collocated properties may not accurately represent the subsurface.

To overcome these issues, an ensemble machine learning model is used in a modular format to predict petrophysical properties in a geological model holistically integrating several inputs that include a combination of geological, geophysical and petrophysical data. A combination of regression and classification machine learning models can be used to develop the ensemble machine learning model. Through the ensemble machine learning model, the data processing system utilizes input data having varied areal coverage and vertical resolution to produce robust petrophysical property distributions within the architectural framework of a 3D geological model. The ensemble machine learning model reduces error amplification that arises during a sequential modeling approach. The ensemble machine learning model can predict spatial distributions for petrophysical properties (e.g., permeability) having high levels of variability, scale dependency and anisotropy. The ensemble machine learning model allows for robust predictions on data that may be limited in quantity and/or quality in complex and heterogenous subsurface formations.

Ensemble machine learning models can provide additional understanding for inter-well 3D static models without needing calibration to account for lack of data. By combining predictions from multiple models, ensemble machine learning models can capture a wide range of patterns and complexities in the data, which in turn can increase accuracy and robustness of predictions. Ensemble machine learning models (e.g., Random Forests or Gradient Boosted Trees) can capture non-linear relationships in data. Machine learning and deep learning models can provide insights into the relative importance of different features used in predictions. The understanding and utilization of significant features can increase accuracy and robustness of predictions. Ensemble machine learning models, such as bagging based models (e.g., random forests), can reduce overfitting of the training data as compared with individual models. Ensemble machine learning models can handle complex interactions between variables, which can be challenging for techniques such as kriging. Ensemble machine learning models can handle different types of data (e.g., categorical data or continuous data) or data with missing values. Some ensemble machine learning models can be trained in parallel reducing computation time. Ensemble machine learning models can be integrated into larger machine learning pipelines. For example, larger pipelines can include data preprocessing, feature engineering, and data postprocessing.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates an example workflow for determining spatial distributions of petrophysical properties of a subsurface formation.

FIG. 2 shows example geological distributions of well log data and volume of silt within a geological model.

FIG. 3 is an example spatial distribution of seismic attributes.

FIG. 4 is an example spatial distribution of geological facies.

FIG. 5 is a schematic diagram of an example stacking ensemble machine learning model.

FIG. 6 is a schematic diagram of an example boosting ensemble machine learning model.

FIG. 7 is a schematic diagram of an example bagging ensemble machine learning model.

FIG. 8 illustrates an example spatial distribution of permeability generated by the workflow of FIG. 1.

FIG. 9 is a flowchart of an example method for determining spatial distributions of petrophysical properties of a subsurface formation.

FIG. 10 illustrates hydrocarbon production operations that include field operations and computational operations, according to some implementations.

FIG. 11 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This disclosure describes systems and methods for spatially distributing petrophysical properties within a three-dimensional subsurface geological model using an ensemble deep learning model. A data processing system (e.g., a computing system or a control system) obtains input data from geophysical data, geological data, and petrophysical data. The data processing system selects input features from the input data. The data processing system forms a training dataset including the input features and corresponding labeled data representing a target petrophysical property. The data processing system trains the ensemble machine learning model using the training dataset. Based on the trained model, the data processing system determines a spatial distribution of the target petrophysical property.

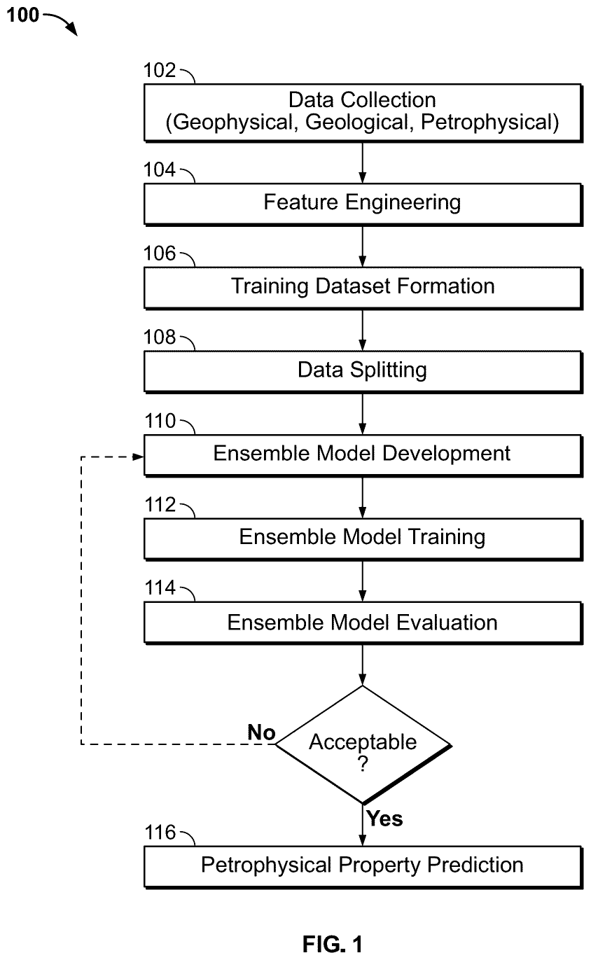

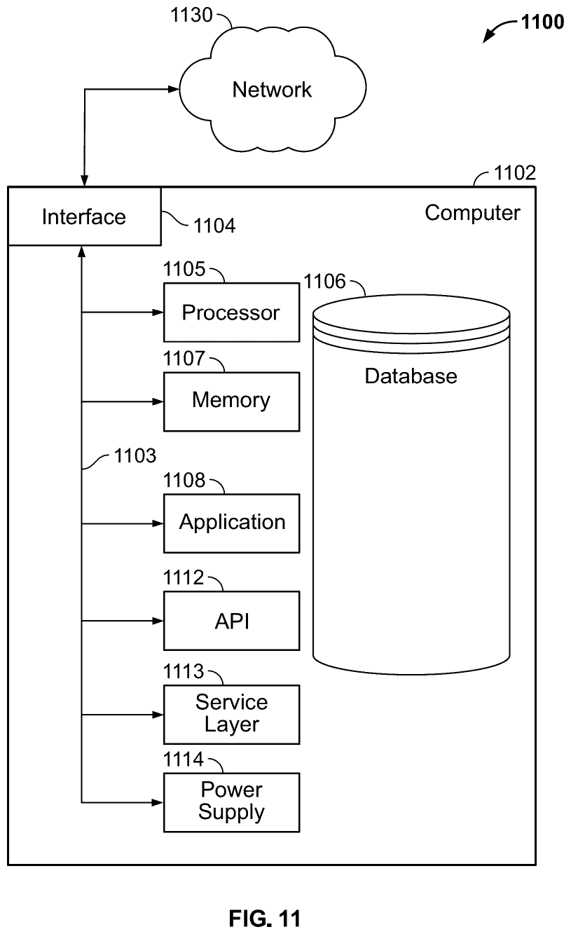

FIG. 1 is a workflow 100 of an example process for determining spatial distributions of petrophysical properties in a subsurface formation. The workflow 100 can be implemented on a data processing system such as a computer or control system (e.g., the computer system of FIG. 11). The workflow 100 can be used to predict spatial distributions of many types of petrophysical properties in the subsurface including, for example, permeability, lithology, and porosity.

At step 102, the data processing system collects input data including geological data, petrophysical data, and geophysical data. Geophysical data can be obtained, for example, from seismic survey data, such as seismic reflection profiles, seismic attributes, velocity models, inversion results (including interpretation of amplitude, time, and phase), frequency, dip and azimuth, and rock property attributes. Petrophysical data can be obtained from interpreted data (e.g., porosity, permeability, lithology, fluid saturations, and mineral volumes) and raw well log data (e.g., density logs, neutron logs, gamma ray logs, sonic logs, borehole image logs, resistivity logs, and Nuclear Magnetic Resonance logs). Petrophysical data can also be obtained from core sample data measured in a laboratory (e.g., minerology, porosity, permeability). Geological data can be obtained from, for example, depositional and diagenetic facies maps, and can include lithology, facies classification, and minerology. Geological data can also include image data from wireline logging imaging tools and image data from logging while drilling tools used for geo-steering.

At step 104, the data processing system selects input features from the input data through feature engineering. Feature engineering can include cleaning the input data, transformation of the data, and creation of new features based on the input data. Domain knowledge and statistical techniques can be used to select input features. For example, the data processing system can perform statistical analysis on the input data to determine a correlation between input features and a target petrophysical property (e.g., permeability, lithology, and porosity). The data processing system selects input features that are well correlated with the target petrophysical property. For example, the data processing system determines that one or more input features have a correlation factor with the target petrophysical property exceeding a specified threshold value. The data processing system then selects the one or more input features.

At step 106, the data processing system forms a training dataset based on the selected input features and labeled data representing the target petrophysical property. The data processing system includes distributing the data within a 3D geological model using stochastic and deterministic techniques. The data processing system can distribute the input features and labeled data to each cell of the 3D geological model. The training dataset can include, for example, raw well log data, petrophysical interpreted data, pre-stacked or post-stacked seismic attributes, and/or depositional/diagenetic geological facies.

Forming the training dataset can also include data augmentation. For example, the selected input features can be augmented with synthetic log and/or synthetic facies data (e.g., synthetic data generated by a machine learning algorithm). The data processing system can generate new, geologically plausible log profiles based on raw petrophysical data to augment the input features. Log data can be transformed to augment data by, for example, determining derivates, filtering or decomposing the log data. Data augmentation can account for data imbalances, apply domain knowledge by exploring deeper data insights, increase performance of a machine learning model, and/or reduce overfitting of the machine learning model.

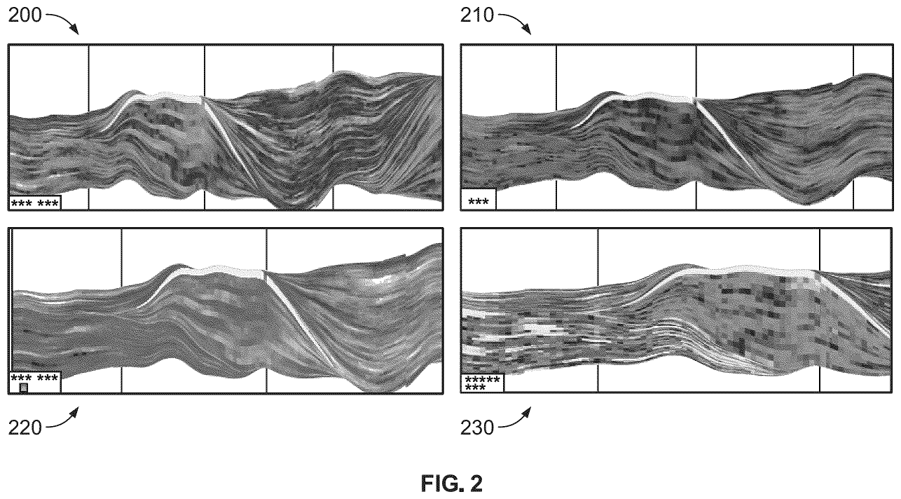

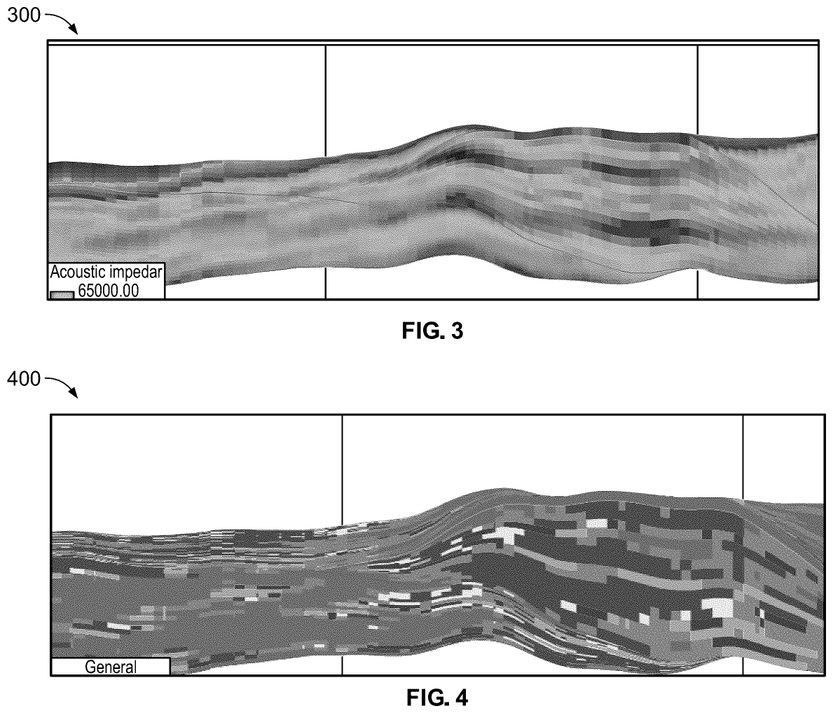

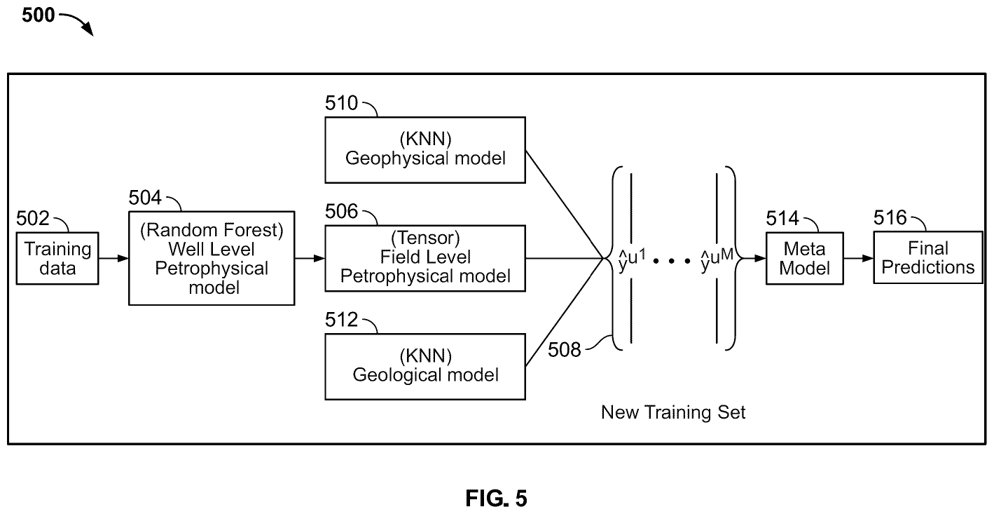

Turning briefly to FIGS. 2-4, example spatial distributions of input features into a geological model are shown. These types of spatial distributions form the input data to the ensemble machine learning model. FIG. 2 shows example distributions of well log data within a geological model including density data 200, neutron porosity (Nphi) 210, sonic transit time (DT) 220, and volume of silt 230 from a petrophysical model. FIG. 3 is an example spatial distribution of seismic attributes 300 (e.g., acoustic impedance). FIG. 4 is an example spatial distribution of geological facies 400 distributed to the geological model architecture through stochastic and deterministic techniques.

Returning to FIG. 1, at step 108, the data processing system splits the training dataset into training, validation, and testing subsets. For example, the data processing system can split the data according to a specified ratio (e.g., 80% training data, 10% validation data, 10% testing data) using random selection. The data processing system uses the training data to adjust the weights of the machine learning model. The data processing system assesses the machine learning model performance during training using the validation subset. The data processing system measures overall performance of the machine learning model using the testing subset.

Geophysical data (e.g., seismic data) can have a large scale areal coverage, but the vertical resolution of the data can be up to 100 feet. Petrophysical and geological data are generally derived from core sampled data and borehole logging data that can have a vertical resolution between nanometers to 1 meter. However, the data can be spatially limited to the sampled environments around the borehole. Developing separate machine learning models for the data having varied resolutions and combining the machine learning models in an ensemble algorithm can greatly increase the accuracy and precision of the final model as compared with a sequentially developed geological model.

At step 110, the data processing system develops the ensemble machine learning model. An ensemble machine learning model is, for example, a meta model including multiple individual machine learning models. The data processing system combines the multiple machine learning models into the ensemble machine learning model to improve the accuracy of the predictions. The ensemble model (meta model) leverages the strengths of multiple individual models by reducing bias and variability of the individual models. Several architectures can be used to develop the ensemble machine learning model including bootstrap aggregation, boosting, stacking, and voting. The structure of these ensemble model architectures is discussed in greater detail with reference to FIGS. 5-7.

Several factors can influence the architecture design of the ensemble machine learning model. For example, complex base models and/or a larger number of base models can be included in the ensemble for large datasets. Different types of features (e.g., categorical, continuous) can indicate certain base models over other base models. In some implementations, diversity among base models (e.g., including different types of base models) of the ensemble machine learning model can lead to better generalization of the ensemble machine learning model. A bagging ensemble machine learning model can be used in implementations with noisy data. The type of problem being addressed with ensemble machine learning model can indicate different ensemble architectures. For example, classification, regression, ranking, and clustering problems can each require a different ensemble architecture. This can also be important when combining different data types such as when combining categorical data (e.g., geological facies data) with continuous data (e.g., petrophysical log data). Some ensemble machine learning models can be better suited for optimizing certain performance metrics (e.g., accuracy, F1-score, ROC-AUC, RMSE). In some implementations, ensemble techniques such as bagging or adding regularization to the ensemble machine learning model can mitigate risks of overfitting when using, for example, a small training dataset or a complex base model. Individual base models can be selected for the ensemble machine learning model to reduce bias, variance, or both. Some ensemble machine learning models (e.g., random forests or Synthetic Minority Over-sampling Technique (SMOTE-boost) models) can be selected for datasets with significant class imbalances. Domain knowledge (e.g., geophysical, petrophysical, geological knowledge) can also guide the selection of base models or the method in which the ensemble predictions are generated.

The design of the ensemble machine learning model can be influenced by, for example, the data quality and quantity, the data variability, the complexity of the modeled reservoir properties, a balanced trade-off between computational complexity and accuracy, and the selection between algorithms and tuning parameters (e.g., regularization, hyper parameterization, normalization weight decay).

In some implementations, selecting the ensemble machine learning model includes determining the individual machine learning models for each dataset included in the training dataset. For example, the individual machine learning models can include random forest models, k-nearest neighbor (KNN) classification models, tensor deep learning models, neural networks, support vector machines, and linear regression models.

The data processing system can adjust hyperparameters of the individual machine learning models and the ensemble machine learning model. Hyperparameters can be external configuration parameters or values that control the learning process. Examples of hyperparameters include learning rate, numbers of layers nodes in a neural network, number of branches in a decision tree, etc. The data processing system can determine values for the hyperparameters using a hyperparameter tuning or hyperparameter optimization algorithm (e.g., grid search, random search, or Bayesian optimization).

At step 112, the data processing system trains the ensemble machine learning model using the training dataset. The training includes training the individual machine learning models and the ensemble model according to the ensemble architecture. In an example training process, the data processing system executes the model on a set of training data during a forward propagation step to generate predicted values. The data processing system determines the value of a loss function based on the predicted values and the labeled data corresponding to the training data. The data processing system adjusts the weights of the machine learning model during a back propagation step based on the value of the loss function using an optimization algorithm (e.g., steepest descent optimization or Adam optimization).

At step 114, the data processing system evaluates the performance of the trained ensemble machine learning model. The data processing system can assess the model based on determining a value of an evaluation metric (e.g., area under the receiver operator characteristic curve (AUC-ROC), F1 score, root mean squared error (RMSE)). The evaluation metric can provide a quantitative measure of how well the predicted values match the labeled values of the training dataset. If the performance of the ensemble machine learning model after training is unacceptable (e.g., evaluation metric is below a specified threshold), the data processing system can return to model development, for example, to adjust a hyperparameter of the model to improve the performance of the ensemble machine learning model.

At step 116, if the performance of the ensemble machine learning model is acceptable, the data processing system determines spatial distributions of the target petrophysical property based on the trained ensemble machine learning model.

Based on the outputs of method 100 (e.g., predicted spatial distributions of petrophysical properties), the data processing system can determine one or more locations to drill wells in the subsurface formation. In response to determining the one or more locations, the data processing system can control one or more drilling equipment to drill wells at one or more of the locations.

FIG. 5 is a workflow of an example stacking ensemble machine learning model 500 based on several individual machine learning models for classification and regression analysis. A stacking model aggregates outputs from multiple well performing models with a meta model producing predicted values. The model 500 receives training data 502 as input into the model. In this example, a random forest model 504 is used to predict a petrophysical property (e.g., permeability) at every well in the training data 502 due to the quantity of core data increasing the overall number of target data. The output of the random forest model 504 is upscaled to field level data by a tensor deep learning model 506. A new training set 508 is formed by combining the output of the tensor model 506 with output from a KNN classification model 510 trained with geological depositional and diagenetic facies and a KNN regression model 512 trained on a velocity model from geological data. The newly developed training dataset 508 can then be used to train a meta model 514 to make predictions 516 in every cell of a geological model.

The stacking ensemble machine learning model 500 provides a way to integrate and optimize the analysis of a geophysical model having large geospatial areal coverage with low vertical resolution with geological and petrophysical data with limited geospatial areal coverage and high vertical resolution.

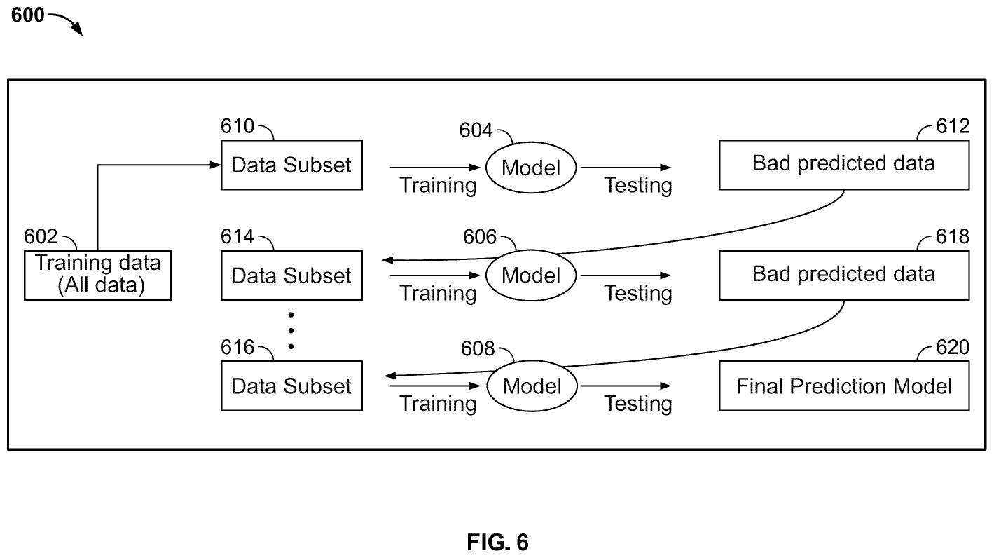

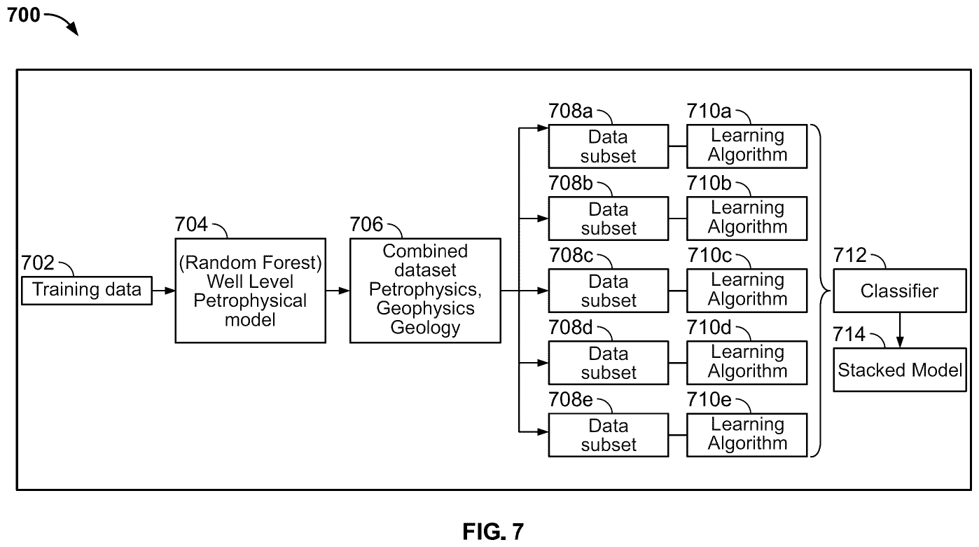

FIG. 6 is a workflow of an example boosting ensemble machine learning model 600. A boosting model can be useful for reducing bias and variance in the output of the model by converting weak learners into strong learners. In this example, the training data 602 includes core permeability data. The individual models 604, 606, 608 are sequentially enhanced by learning based on errors from the previous model to produce models that are designed to produce low bias and variability. The individual models 604, 606, 608 used in this workflow can be any type of machine learning classification or regression model. For example, the model 604 receives as input a subset 610 of data from the training dataset 602. The model 604 is evaluated and incorrectly predicted data 612 is formed into a data subset 614 to be input into the subsequent model 606. This process can be iteratively repeated for a desired number of iterations. The final model 608 takes as input a data subset 616 formed from the incorrectly predicted data 618 from the previous model 606. After training, the output 620 of the final model 608 is the spatial distribution of the target petrophysical property. As with the stacking model 500, the boosting model 600 can integrate input feature data with different vertical resolutions.

In some implementations, the boosting model is an adaptive boosting model (AdaBoost) where each subsequent model corrects the mistakes of its predecessors. In some implementations, the boosting model is a Gradient Boosting Machine (GBM), which sequentially adds models to the ensemble to correct the residuals of the combined ensemble of all previous models. Some available libraries can offer additional improvements over traditional GBMs, for example, XGBoost, LightGBM, CatBoost:Optimized and scalable gradient boosting. In some implementations, a Regularized Greedy Forest (RGF) can be used. An RGF is a model that builds on decision trees and gradient boosting and introduces regularization to enhance performance.

FIG. 7 is a workflow for a bootstrap aggregation (bagging) ensemble machine learning model 700. In this example, a random forest model 704 receives training data 702 including well log and core data to predict a continuous permeability profile. This newly generated permeability profile has a larger number of data points for training a larger scale 3D model. The permeability profile is combined with selected input features from the geological, geophysical, and petrophysical datasets. This combined dataset 706 is then randomly sampled with replacement to form data subsets 708a-e. Weak learning models 710a-e are trained on the respective data subsets 708a-e. Output from the weak learning models 710a-e are aggregated by a classifier 712 that uses a weighted average to determine the final predicted spatial distribution of the target petrophysical property 714. A bagging model is useful to minimize overfitting for machine learning models with large variabilities and low biases. The bagging model also provides a method of integrating data with different geospatial coverage and vertical resolutions.

In some implementations, the bagging ensemble machine learning model includes an ensemble of random forest decision trees that are each trained on a bootstrapped sample of the training data using a random subset of features at each split in the decision tree. The predictions from the multiple decision trees can be averaged (e.g., for a regression model) or majority voted (e.g., for classification).

Other types of ensemble machine learning models can be used in the workflow 100. For example, a voting ensemble machine learning model can be used where each base model in the ensemble votes for a class, and the class with the majority votes is chosen (e.g., hard voting). In a soft voting model, the probabilities or confidence scores output by base models can be averages, and the class with the highest average is chosen. In some implementations, the ensemble machine learning model is a neural network ensemble where multiple neural networks are trained and their predictions are combined using bagging, boosting, or other ensemble technique (e.g., Bayesian Model Averaging (BMA) or Bayesian Model Combination (BMC)).

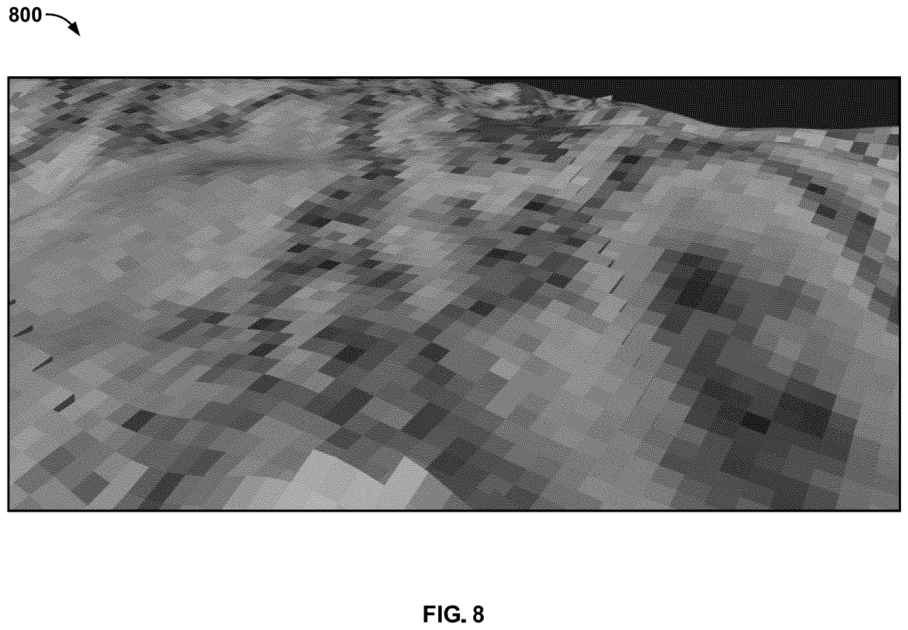

FIG. 8 illustrates a visual representation 800 of a geological model where permeability has been spatially predicted in every cell using an ensemble deep learning approach (e.g., method 100). The performance of this model can be evaluated using blind tests in selected wells and comparisons with dynamic data (e.g., Drill Stem Test data, Formation Test data).

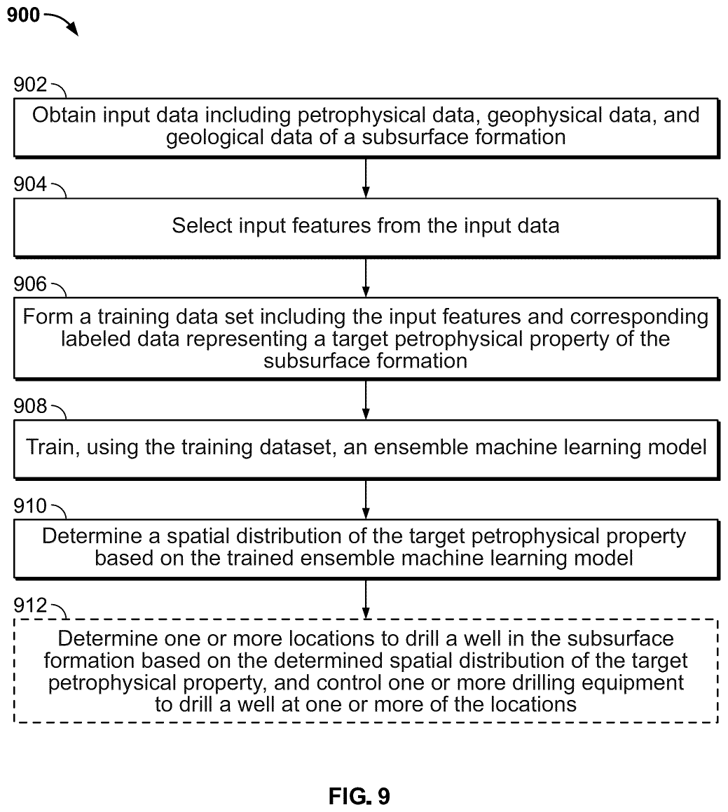

FIG. 9 is a flow chart of a method 900 for determining spatial distributions of petrophysical properties in a subsurface formation.

At step 902, a data processing system obtains input data comprising petrophysical data, geophysical data, and geological data of the subsurface formation. For example, the data processing system can access the input data from a data store. The input data can include data from geological and geophysical exploration operations including seismic surveys, well logging, and core sampling. The petrophysical data, the geophysical data, and the geological data can each have different spatial resolutions.

At step 904, the data processing system selects input features from the input data. In some implementations, the data processing system performs a statistical analysis of the input data to determine input features that are correlated with the target petrophysical property.

At step 906, the data processing system forms a training dataset including the input features and corresponding labeled data representing a target petrophysical property of the subsurface formation. In some implementations, the data processing system spatially distributes the input features in a 3D geological model based on stochastic and deterministic methods.

At step 908, the data processing system trains an ensemble machine learning model, using the training dataset. In some implementations, the ensemble machine learning model is at least one of a bagging model, a boosting model, or a stacking model.

At step 910, the data processing system determines a spatial distribution of the target petrophysical property based on the trained ensemble machine learning model. In some implementations, the target petrophysical property is permeability, lithology, or porosity.

In some implementations, at step 912, the data processing system determines one or more locations to drill a well in the subsurface formation based on the determined spatial distribution of the target petrophysical property; and in response to determining the one or more locations to drill a well, the data processing system controls one or more drilling equipment to drill a well at one or more of the locations.

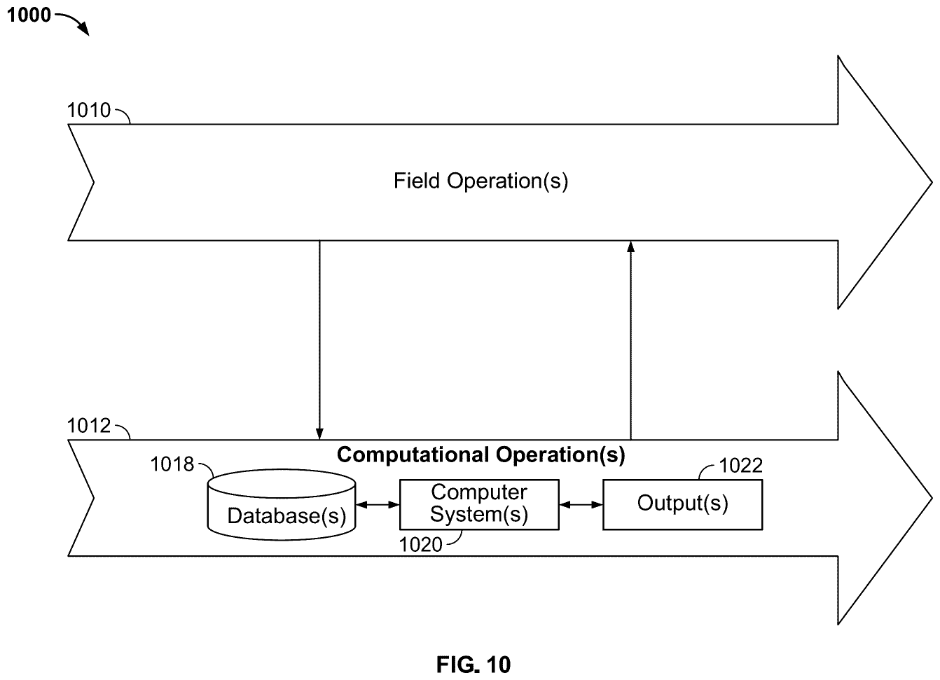

FIG. 10 illustrates hydrocarbon production operations 1000 that include both one or more field operations 1010 and one or more computational operations 1012, which exchange information and control exploration for the production of hydrocarbons. In some implementations, outputs of techniques of the present disclosure (e.g., the workflow 100 or method 900) can be performed before, during, or in combination with the hydrocarbon production operations 1000, specifically, for example, either as field operations 1010 or computational operations 1012, or both.

Examples of field operations 1010 include forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively, or in addition, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate three-dimensional (3D) maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 11 is a block diagram of an example computer system 1100 used to provide computational functionalities associated with described algorithms, methods, functions, processes, flows, and procedures described in the present disclosure, according to some implementations of the present disclosure. The illustrated computer 1102 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1102 can include input devices such as keypads, keyboards, and touch screens that can accept user information. Also, the computer 1102 can include output devices that can convey information associated with the operation of the computer 1102. The information can include digital data, visual data, audio information, or a combination of information. The information can be presented in a graphical user interface (UI) (or GUI).

The computer 1102 can serve in a role as a client, a network component, a server, a database, a persistency, or components of a computer system for performing the subject matter described in the present disclosure. The illustrated computer 1102 is communicably coupled with a network 1130. In some implementations, one or more components of the computer 1102 can be configured to operate within different environments, including cloud-computing-based environments, local environments, global environments, and combinations of environments.

At a high level, the computer 1102 is an electronic computing device operable to receive, transmit, process, store, and manage data and information associated with the described subject matter. According to some implementations, the computer 1102 can also include, or be communicably coupled with, an application server, an email server, a web server, a caching server, a streaming data server, or a combination of servers.

The computer 1102 can receive requests over network 1130 from a client application (for example, executing on another computer 1102). The computer 1102 can respond to the received requests by processing the received requests using software applications. Requests can also be sent to the computer 1102 from internal users (for example, from a command console), external (or third) parties, automated applications, entities, individuals, systems, and computers.

Each of the components of the computer 1102 can communicate using a system bus 1103. In some implementations, any or all of the components of the computer 1102, including hardware or software components, can interface with each other or the interface 1104 (or a combination of both), over the system bus 1103. Interfaces can use an application programming interface (API) 1112, a service layer 1113, or a combination of the API 1112 and service layer 1113. The API 1112 can include specifications for routines, data structures, and object classes. The API 1112 can be either computer-language independent or dependent. The API 1112 can refer to a complete interface, a single function, or a set of APIs.

The service layer 1113 can provide software services to the computer 1102 and other components (whether illustrated or not) that are communicably coupled to the computer 1102. The functionality of the computer 1102 can be accessible for all service consumers using this service layer. Software services, such as those provided by the service layer 1113, can provide reusable, defined functionalities through a defined interface. For example, the interface can be software written in JAVA, C++, or a language providing data in extensible markup language (XML) format. While illustrated as an integrated component of the computer 1102, in alternative implementations, the API 1112 or the service layer 1113 can be stand-alone components in relation to other components of the computer 1102 and other components communicably coupled to the computer 1102. Moreover, any or all parts of the API 1112 or the service layer 1113 can be implemented as child or sub-modules of another software module, enterprise application, or hardware module without departing from the scope of the present disclosure.

The computer 1102 includes an interface 1104. Although illustrated as a single interface 1104 in FIG. 11, two or more interfaces 1104 can be used according to particular needs, desires, or particular implementations of the computer 1102 and the described functionality. The interface 1104 can be used by the computer 1102 for communicating with other systems that are connected to the network 1130 (whether illustrated or not) in a distributed environment. Generally, the interface 1104 can include, or be implemented using, logic encoded in software or hardware (or a combination of software and hardware) operable to communicate with the network 1130. More specifically, the interface 1104 can include software supporting one or more communication protocols associated with communications. As such, the network 1130 or the interface's hardware can be operable to communicate physical signals within and outside of the illustrated computer 1102.

The computer 1102 includes a processor 1105. Although illustrated as a single processor 1105 in FIG. 11, two or more processors 1105 can be used according to particular needs, desires, or particular implementations of the computer 1102 and the described functionality. Generally, the processor 1105 can execute instructions and can manipulate data to perform the operations of the computer 1102, including operations using algorithms, methods, functions, processes, flows, and procedures as described in the present disclosure.

The computer 1102 also includes a database 1106 that can hold data for the computer 1102 and other components connected to the network 1130 (whether illustrated or not). For example, database 1106 can be an in-memory, conventional, or a database storing data consistent with the present disclosure. In some implementations, database 1106 can be a combination of two or more different database types (for example, hybrid in-memory and conventional databases) according to particular needs, desires, or particular implementations of the computer 1102 and the described functionality. Although illustrated as a single database 1106 in FIG. 11, two or more databases (of the same, different, or combination of types) can be used according to particular needs, desires, or particular implementations of the computer 1102 and the described functionality. While database 1106 is illustrated as an internal component of the computer 1102, in alternative implementations, database 1106 can be external to the computer 1102.

The computer 1102 also includes a memory 1107 that can hold data for the computer 1102 or a combination of components connected to the network 1130 (whether illustrated or not). Memory 1107 can store any data consistent with the present disclosure. In some implementations, memory 1107 can be a combination of two or more different types of memory (for example, a combination of semiconductor and magnetic storage) according to particular needs, desires, or particular implementations of the computer 1102 and the described functionality. Although illustrated as a single memory 1107 in FIG. 11, two or more memories 1107 (of the same, different, or combination of types) can be used according to particular needs, desires, or particular implementations of the computer 1102 and the described functionality. While memory 1107 is illustrated as an internal component of the computer 1102, in alternative implementations, memory 1107 can be external to the computer 1102.

The application 1108 can be an algorithmic software engine providing functionality according to particular needs, desires, or particular implementations of the computer 1102 and the described functionality. For example, application 1108 can serve as one or more components, modules, or applications. Further, although illustrated as a single application 1108, the application 1108 can be implemented as multiple applications 1108 on the computer 1102. In addition, although illustrated as internal to the computer 1102, in alternative implementations, the application 1108 can be external to the computer 1102.

The computer 1102 can also include a power supply 1114. The power supply 1114 can include a rechargeable or non-rechargeable battery that can be configured to be either user- or non-user-replaceable. In some implementations, the power supply 1114 can include power-conversion and management circuits, including recharging, standby, and power management functionalities. In some implementations, the power-supply 1114 can include a power plug to allow the computer 1102 to be plugged into a wall socket or a power source to, for example, power the computer 1102 or recharge a rechargeable battery.

There can be any number of computers 1102 associated with, or external to, a computer system containing computer 1102, with each computer 1102 communicating over network 1130. Further, the terms “client,” “user,” and other appropriate terminology can be used interchangeably, as appropriate, without departing from the scope of the present disclosure. Moreover, the present disclosure contemplates that many users can use one computer 1102 and one user can use multiple computers 1102.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

### Examples

In an example implementation, a method for determining spatial distributions of petrophysical properties in a subsurface formation includes obtaining input data including petrophysical data, geophysical data and geological data of the subsurface formation; selecting input features from the input data; forming a training dataset including the input features and corresponding labeled data representing a target petrophysical property of the subsurface formation; training, using the training dataset, an ensemble machine learning model; and determining a spatial distribution of the target petrophysical property based on the trained ensemble machine learning model.

An aspect combinable with the example implementation includes determining one or more locations to drill a well in the subsurface formation based on the determined spatial distribution of the target petrophysical property; and in response to determining the one or more locations to drill a well, controlling one or more drilling equipment to drill a well at one or more of the locations.

In another aspect combinable with any of the previous aspects, the target petrophysical property includes permeability.

In another aspect combinable with any of the previous aspects, selecting input features includes performing a statistical analysis of the input data to determine input features that are correlated with the target petrophysical property.

In another aspect combinable with any of the previous aspects, the ensemble machine learning model includes at least one of a stacking model, a bagging model, or a boosting model.

In another aspect combinable with any of the previous aspects, forming the training dataset includes spatially distributing the input features in a three-dimensional geological model based on stochastic and deterministic methods.

In another aspect combinable with any of the previous aspects, the petrophysical data, the geophysical data, and the geological data each have different spatial resolutions.

In another example implementations, a system for determining spatial distributions of petrophysical properties in a subsurface formation includes at least one processor and a memory storing instructions that, when executed by the at least one processor, cause the at least one processor to perform operations including obtaining input data including petrophysical data, geophysical data and geological data of the subsurface formation; selecting input features from the input data; forming a training dataset including the input features and corresponding labeled data representing a target petrophysical property of the subsurface formation; training, using the training dataset, an ensemble machine learning model; and determining a spatial distribution of the target petrophysical property based on the trained ensemble machine learning model.

In an aspect combinable with the example implementation, the operations further include determining one or more locations to drill a well in the subsurface formation based on the determined spatial distribution of the target petrophysical property; and in response to determining the one or more locations to drill a well, controlling one or more drilling equipment to drill a well at one or more of the locations.

In another aspect combinable with any of the previous aspects, the target petrophysical property includes permeability.

In another aspect combinable with any of the previous aspects, selecting input features includes performing a statistical analysis of the input data to determine input features that are correlated with the target petrophysical property.

In another aspect combinable with any of the previous aspects, the ensemble machine learning model includes at least one of a stacking model, a bagging model, or a boosting model.

In another aspect combinable with any of the previous aspects, forming the training dataset includes spatially distributing the input features in a three-dimensional geological model based on stochastic and deterministic methods.

In another aspect combinable with any of the previous aspects, the petrophysical data, the geophysical data, and the geological data each have different spatial resolutions.

In another example implementation, one or more non-transitory machine-readable storage devices storing instructions for determining spatial distributions of petrophysical properties in a subsurface formation, the instructions being executable by one or more processors, to cause performance of operations including obtaining input data including petrophysical data, geophysical data and geological data of the subsurface formation; selecting input features from the input data; forming a training dataset including the input features and corresponding labeled data representing a target petrophysical property of the subsurface formation; training, using the training dataset, an ensemble machine learning model; and determining a spatial distribution of the target petrophysical property based on the trained ensemble machine learning model.

In an aspect combinable with the example implementation, the operations include determining one or more locations to drill a well in the subsurface formation based on the determined spatial distribution of the target petrophysical property; and in response to determining the one or more locations to drill a well, controlling one or more drilling equipment to drill a well at one or more of the locations.

In another aspect combinable with any of the previous aspects, the target petrophysical property includes permeability.

In another aspect combinable with any of the previous aspects, selecting input features includes performing a statistical analysis of the input data to determine input features that are correlated with the target petrophysical property.

In another aspect combinable with any of the previous aspects, the ensemble machine learning model includes at least one of a stacking model, a bagging model, or a boosting model.

In another aspect combinable with any of the previous aspects, forming the training dataset includes spatially distributing the input features in a three-dimensional geological model based on stochastic and deterministic methods; and the petrophysical data, the geophysical data, and the geological data each have different spatial resolutions.

What is claimed is:

1. A method for determining spatial distributions of petrophysical properties in a subsurface formation, the method comprising:
obtaining input data comprising petrophysical data, geophysical data and geological data of the subsurface formation;
selecting input features from the input data;
forming a training dataset including the input features and corresponding labeled data representing a target petrophysical property of the subsurface formation;
training, using the training dataset, an ensemble machine learning model; and
determining a spatial distribution of the target petrophysical property based on the trained ensemble machine learning model.

2. The method of claim 1, further comprising:
determining one or more locations to drill a well in the subsurface formation based on the determined spatial distribution of the target petrophysical property; and
in response to determining the one or more locations to drill a well, controlling one or more drilling equipment to drill a well at one or more of the locations.

3. The method of claim 1, wherein the target petrophysical property comprises permeability.

4. The method of claim 1, wherein selecting input features comprises: performing a statistical analysis of the input data to determine input features that are correlated with the target petrophysical property.

5. The method of claim 1, wherein the ensemble machine learning model comprises at least one of a stacking model, a bagging model, or a boosting model.

6. The method of claim 1, wherein forming the training dataset comprises spatially distributing the input features in a three-dimensional geological model based on stochastic and deterministic methods.

7. The method of claim 1, wherein the petrophysical data, the geophysical data, and the geological data each have different spatial resolutions.

8. A system for determining spatial distributions of petrophysical properties in a subsurface formation, the system comprising:
at least one processor and a memory storing instructions that, when executed by the at least one processor, cause the at least one processor to perform operations comprising:
obtaining input data comprising petrophysical data, geophysical data and geological data of the subsurface formation;
selecting input features from the input data;
forming a training dataset including the input features and corresponding labeled data representing a target petrophysical property of the subsurface formation;
training, using the training dataset, an ensemble machine learning model; and
determining a spatial distribution of the target petrophysical property based on the trained ensemble machine learning model.

9. The system of claim 8, wherein the operations further comprise:
determining one or more locations to drill a well in the subsurface formation based on the determined spatial distribution of the target petrophysical property; and
in response to determining the one or more locations to drill a well, controlling one or more drilling equipment to drill a well at one or more of the locations.

10. The system of claim 8, wherein the target petrophysical property comprises permeability.

11. The system of claim 8, wherein selecting input features comprises:
performing a statistical analysis of the input data to determine input features that are correlated with the target petrophysical property.

12. The system of claim 8, wherein the ensemble machine learning model comprises at least one of a stacking model, a bagging model, or a boosting model.

13. The system of claim 8, wherein forming the training dataset comprises:
spatially distributing the input features in a three-dimensional geological model based on stochastic and deterministic methods.

14. The system of claim 8, wherein the petrophysical data, the geophysical data, and the geological data each have different spatial resolutions.

15. One or more non-transitory machine-readable storage devices storing instructions for determining spatial distributions of petrophysical properties in a subsurface formation, the instructions being executable by one or more processors, to cause performance of operations comprising:
obtaining input data comprising petrophysical data, geophysical data and geological data of the subsurface formation;
selecting input features from the input data;
forming a training dataset including the input features and corresponding labeled data representing a target petrophysical property of the subsurface formation;
training, using the training dataset, an ensemble machine learning model; and
determining a spatial distribution of the target petrophysical property based on the trained ensemble machine learning model.

16. The non-transitory machine-readable storage devices of claim 15, wherein the operations further comprise:
determining one or more locations to drill a well in the subsurface formation based on the determined spatial distribution of the target petrophysical property; and
in response to determining the one or more locations to drill a well, controlling one or more drilling equipment to drill a well at one or more of the locations.

17. The non-transitory machine-readable storage devices of claim 15, wherein the target petrophysical property comprises permeability.

18. The non-transitory machine-readable storage devices of claim 15, wherein selecting input features comprises: performing a statistical analysis of the input data to determine input features that are correlated with the target petrophysical property.

19. The non-transitory machine-readable storage devices of claim 15, wherein the ensemble machine learning model comprises at least one of a stacking model, a bagging model, or a boosting model.

20. The non-transitory machine-readable storage devices of claim 15, wherein forming the training dataset comprises spatially distributing the input features in a three-dimensional geological model based on stochastic and deterministic methods; and
wherein the petrophysical data, the geophysical data, and the geological data each have different spatial resolutions.
